(19) United States
(12) Patent Application Publication
(10) Pub. No.: US 2018/0345896 A1
(43) Pub. Date: Dec. 6, 2018

(54) Motor Vehicle Seat Having an Occupant Safety System

(71) Applicant: Ford Global Technologies, LLC, Dearborn, MI (US)

(72) Inventors: Frank WERNER, Odenthal NRW (DE); Marius SAWATZKI, Pulheim NRW (DE); Martin SALZ-BREUER, Bonn NRW (DE); Daniel MECKENSTOCK, Wuppertal NRW (DE)

(73) Assignee: Ford Global Technologies, LLC, Dearborn, MI (US)

(21) Appl. No.: 15/991,253

(22) Filed: May 29, 2018

(30) Foreign Application Priority Data
May 31, 2017 (DE) 10 2017 209 210.6

(51) Int. Cl. B60R 21/207

(52) U.S. Cl. CPC B60R 21/207; B60R 2021/0006

(57) ABSTRACT

An occupant safety system for a vehicle seat is disclosed. The motor vehicle seat has a seat face, a backrest that is adjacent to the seat face and a headrest that is arranged at an upper side of the backrest. At least one airbag is arranged in the headrest. The at least one airbag is constructed in such a manner that, in an inflated state, the at least one airbag prevents an occupant without any belt system from contacting a vehicle roof by acting on shoulders of an occupant in the seat.

### CROSS-REFERENCE TO RELATED APPLICATION

This application claims foreign priority benefits under 35 U.S.C. § 119(a)-(d) to DE Application 10 2017 209 210.6 filed May 31, 2017, which is hereby incorporated by reference in its entirety.

### TECHNICAL FIELD

The disclosure relates to an airbag safety system for a motor vehicle seat.

### BACKGROUND

It is generally known in motor vehicles to use a large number of occupant safety systems. Many systems are based on use of different airbags, some of which are arranged directly on the motor vehicle seats, such as side or head airbags.

U.S. Pat. No. 9,533,651 B1 discloses an occupant safety system that uses a hood-like head airbag, which is accommodated in the headrest of a motor vehicle seat and, when deployed, covers a head of an occupant. The system requires a seatbelt in order to prevent the occupant from moving forward, otherwise his head would be held back by the airbag and the torso would slide forward, and consequently bend the head or neck.

US 2007/126213 A1 discloses a head/side airbag/belt combination for protecting a head in the event of a side impact or rollover. Only together with the belt does local protection of an occupant apply laterally, and to a very small movement extent also in an upward direction.

However, there is still the desire for an occupant safety system on a motor vehicle seat that, even without a seatbelt, protects an occupant from undesirable contact of a head with a vehicle roof.

### SUMMARY

According to the disclosure, it has been recognized that it is possible to allow an unbelted occupant to carry out a controlled movement in a purely x direction (travel direction) in the vehicle if at least one airbag, which is arranged in a headrest or in an upper seat region, is constructed in such a manner that, in an inflated state, the airbag prevents an occupant without any belt system from carrying out an upward movement in a +z direction by acting on occupant shoulders and thereby prevents contact with a vehicle roof. In this instance, no control is applied to head movement.

The proposed shoulder airbags press from above onto the shoulders of the occupant and limit their upward movement, brought about by an impulse of a rising vehicle structure, or prevent the upward movement. A contact of a head with a so-called “roof header” (strut at a transition between a windshield and roof) can be prevented in this manner.

There are preferably arranged in the headrest or in the upper seat region two airbags that, in the inflated state, each extend and are constructed laterally and in a forward direction from the headrest in a longitudinal vehicle direction and act only on the shoulders of the occupant.

Another preferred construction variant is that the airbag is constructed in such a manner that the airbag can simultaneously expand upward, fill space between the occupant shoulder and roof, and, during an occupant movement phase, can be supported on the roof.

Each airbag comprises a bubble that together, in the inflated state, form a corridor to control movement of the occupant in the longitudinal direction of the vehicle. The corridor may be a predetermined movement corridor for the occupant that is intended to prevent unnecessary contact with surrounding vehicle components. The use of the disclosure is planned without a belt system since it is intended to cover a so-called “unbelted test mode” in which occupants are not belted in.

The motor vehicle seat is characterized in that an actuation control having a vertical impulse sensor is provided so that at least one airbag is deployed by the control when the sensor detects that a predetermined impulse in the vertical direction has been exceeded.

The disclosure relates to the unbelted case. The position of the head and upper body is not fixed in this instance, but instead changes in the longitudinal direction of the vehicle.

The present disclosure relates, in other words, to an airbag on a left and right shoulder of the occupant that produce a continuous force, which is directed downward in order to compensate for a positive vertical impulse of the vehicle in an event of an impact.

Other features and details of the disclosure will be appreciated from the following description of the drawings, in which:

### BRIEF DESCRIPTION OF THE DRAWINGS

FIG. 1 is a schematic front view of an occupant compartment; and

FIG. 2 is a schematic side view of the occupant compartment from FIG. 1.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

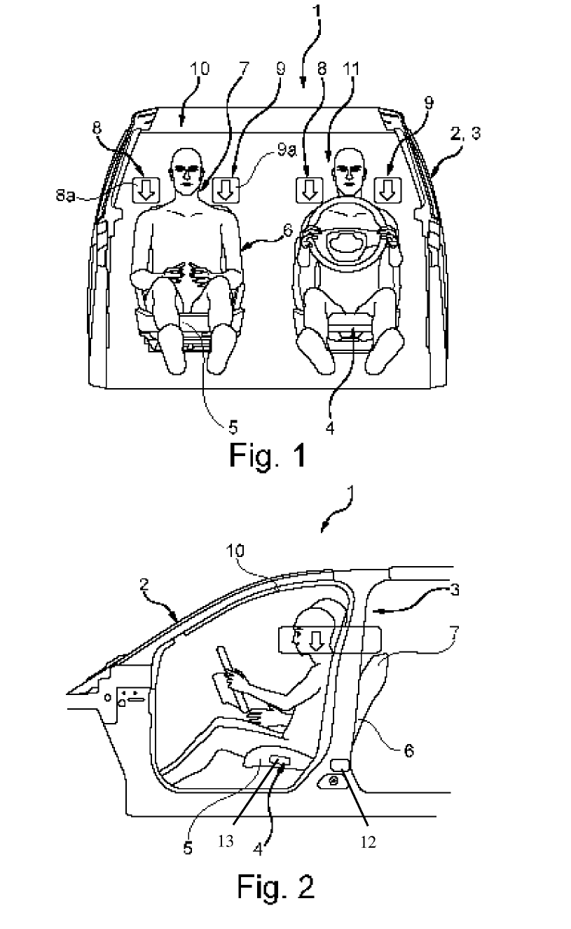

In FIGS. 1 and 2, an occupant compartment 1 is shown in a region of a front seat 4 between an A-pillar 2 and B-pillar 3 of a vehicle.

The front seats 4 have a seat face 5, an adjacent backrest 6 and a headrest 7 that is arranged at an upper side of the backrest 6.

In the headrest 7 are two airbags 8, 9 that are constructed in such a manner that, in an inflated state, the two airbags 8, 9 prevent an occupant, via action on shoulders without any belt system, from coming into contact with a vehicle roof 10.

The two airbags 8, 9 are shown in FIGS. 1 and 2, deployed, in the inflated state, in which the two airbags 8, 9 each extend, and are constructed laterally and forward, from the headrest 7 in a longitudinal direction of the vehicle. The two airbags 8, 9 act only on the shoulders of the occupant, which is indicated by arrows.

Otherwise, an occupant head remains free.

Each of the airbags 8, 9 comprises a single bubble 8a, 9a that, together in the inflated state, form a corridor 11 to control movement of the occupant in the longitudinal direction of the vehicle.

In each respective seat 4, an actuation controller 12 is provided with a vertical impulse sensor 13 in order to deploy the airbags 8, 9 when the sensor 13 detects that a predetermined impulse in the vertical direction (in the event of an impact) has been exceeded. The controller 12 may be a microprocessor configured to actuate the airbags in response to a signal from the impulse sensor 13. The impulse sensor 13 may be any sensor configured to detect a vertical impulse, such as, for example, an accelerometer, a pressure sensor, or any other sensor that may detect a vertical impulse.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle occupant safety system, comprising:
a seat having a seat face adjacent to a backrest and a headrest arranged at an upper side of the backrest; and
a first airbag arranged in the headrest and constructed such that, in an inflated state, the first airbag constrains occupant shoulders to prevent an occupant from contacting a roof in an absence of a belt system.

2. The vehicle occupant safety system as claimed in claim 1 further comprising a second airbag arranged in the headrest such that, in the inflated state, the first and second airbags extend in a forward direction and are constructed laterally from the headrest in a longitudinal vehicle direction and act only on the occupant shoulders.

3. The vehicle occupant safety system as claimed in claim 2, wherein the first and second airbags each include a bubble such that, in the inflated state, each bubble of the first and second airbags forms a corridor that controls movement of the occupant in the longitudinal direction of the vehicle.

4. The vehicle occupant safety system as claimed in claim 1 wherein each of the first and second airbags is constructed such that the first and second airbags simultaneously expand upward to fill space between the occupant shoulder and a roof during an occupant movement phase and are supported on the roof.

5. The vehicle occupant safety system as claimed in claim 1 further comprising an actuation controller having a vertical impulse sensor and configured to, in response to the sensor exceeding a predetermined impulse in a vertical direction, deploy the first airbag.

6. A vehicle comprising:
a seat having a seat face adjacent to a backrest and a headrest arranged at an upper side of the backrest; and
first and second airbags arranged in the headrest and constructed such that, in an inflated state, the first and second airbags extend in a forward vehicle direction and are constructed laterally from the headrest in a longitudinal vehicle direction to each constrain an occupant shoulder to prevent an occupant from contacting a roof in an absence of a belt system.

7. The vehicle as claimed in claim 6, wherein the first and second airbags each include a bubble such that, in the inflated state, each bubble of the first and second airbags forms a corridor that controls movement of the occupant in the longitudinal direction of the vehicle.

8. The vehicle as claimed in claim 6, wherein each of the first and second airbags is constructed such that the first and second airbags simultaneously expand upward to fill space between the occupant shoulders and a roof during an occupant movement phase and are supported on the roof.

9. The vehicle as claimed in claim 6 further comprising an actuation controller having a vertical impulse sensor and configured to, in response to the sensor exceeding a predetermined impulse in a vertical direction, deploy the first and second airbags.

10. A vehicle seat comprising:
a seat face adjacent to a backrest;
a headrest arranged at an upper side of the backrest; and
first and second airbags arranged in the headrest and constructed such that, in an inflated state, the first and second airbags extend in a forward direction and are constructed laterally from the headrest in a longitudinal vehicle direction to each constrain an occupant shoulder to prevent an occupant from contacting a roof in an absence of a belt system.

11. The vehicle seat as claimed in claim 10, wherein the first and second airbags each include a bubble such that, in the inflated state, each bubble of the first and second airbags forms a corridor that controls movement of the occupant in the longitudinal direction of the vehicle.

12. The vehicle seat as claimed in claim 10, wherein each of the first and second airbags is constructed such that the first and second airbags simultaneously expand upward to fill space between the occupant shoulder and a roof during an occupant movement phase and are supported on the roof.

13. The vehicle seat as claimed in claim 10 further comprising an actuation controller having a vertical impulse sensor and configured to, in response to the sensor exceeding a predetermined impulse in a vertical direction, deploy the first and second airbags.
